(19) United States
(12) Patent Application Publication
(10) Pub. No.: US 2022/0343042 A1
(43) Pub. Date: Oct. 27, 2022

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventor: Tomoyuki SUZUKI, Shinagawa Tokyo (JP)

(73) Assignee: KABUSHIKI KAISHA TOSHIBA, Tokyo (JP)

(21) Appl. No.: 17/685,259

(22) Filed: Mar. 2, 2022

(30) Foreign Application Priority Data
Apr. 22, 2021 (JP) 2021-072646

(51) Int. Cl. G06F 30/27

(52) U.S. Cl. CPC G06F 30/27; G06F 2111/10

(57) ABSTRACT

According to an embodiment, an information processing device includes a memory and one or more processors coupled to the memory. The memory stores therein time-series data including one or more variables. The one or more processors are configured to: calculate one or more time differential values of the one or more variables; calculate one or more differences representing variation of the one or more variables from an initial value; estimate a coefficient of a linear regression equation by machine learning in which the time differential values and the differences are used as learning data; and output the linear regression equation.

### CROSS-REFERENCE TO RELATED APPLICATIONS

This application is based upon and claims the benefit of priority from Japanese Patent Application No. 2021-072646, filed on Apr. 22, 2021; the entire contents of which are incorporated herein by reference.

### FIELD

Embodiments described herein relate generally to an information processing device, an information processing method, and a computer program product.

### BACKGROUND

Conventionally, techniques for modelling a physical phenomenon have been known. For example, there are techniques for obtaining a mathematical model describing a physical phenomenon from time-series data by applying symbolic regression, which is a type of machine learning.

However, in the conventional techniques, it has been difficult to further improve the accuracy of generating a model of a physical phenomenon.

### BRIEF DESCRIPTION OF THE DRAWINGS

FIG. 1 is a diagram illustrating an example of temperature change in components obtained from certain results of thermal fluid analysis;

FIG. 2 is a diagram for explaining a time step (Δt);

FIG. 3 is a diagram illustrating an example of a functional configuration of an information processing device according to an embodiment;

FIG. 4 is a flowchart illustrating an example of a generation method of a model according to the embodiment;

FIG. 5 is a diagram illustrating an example of a power electronic apparatus that is an object subject to thermal fluid analysis;

FIG. 6 is a diagram illustrating an example of a component configuration of an electronic apparatus;

FIG. 7 is a diagram illustrating an example of temperature measurement points on a heat sink;

FIG. 8 is a diagram illustrating an example of the number and position of chips of the power electronic apparatus;

FIG. 9 is a diagram illustrating Example 1 of unknown input data to be input into a model generated by the information processing device according to the embodiment;

FIG. 10 is a diagram illustrating Example 1 of results (when Example 1 of input data is input) predicted by the model generated by the information processing device according to the embodiment;

FIG. 11A is a diagram illustrating Example 2 of unknown input data to be input into the model generated by the information processing device according to the embodiment;

FIG. 11B is a diagram illustrating Example 2 of unknown input data to be input into the model generated by the information processing device according to the embodiment;

FIG. 12 is a diagram illustrating Example 2 of results (when Example 2 of input data is input) predicted by the model generated by the information processing device according to the embodiment; and

FIG. 13 is a diagram illustrating an example of a hardware configuration of the information processing device according to the embodiment.

### DETAILED DESCRIPTION

According to an embodiment, an information processing device includes a memory and one or more processors coupled to the memory. The memory is configured to store therein time-series data including one or more variables. The one or more processors are configured to: calculate one or more time differential values of the one or more variables; calculate one or more differences representing variation of the one or more variables from an initial value; estimate a coefficient of a linear regression equation by machine learning in which the time differential values and the differences are used as learning data; and output the linear regression equation.

Hereinafter, an embodiment of an information processing device, an information processing method, and a computer program product will be described in detail with reference to the accompanying drawings.

In a method described in S. L. Brunton, J. L. Proctor, J. N. Kutz, “Discovering governing equations from data by sparse identification of nonlinear dynamical systems”, Proc. Natl. Acad. Sci., 113 (2016), pp. 3932-3937 in which symbolic regression is developed, the following equation (1) is used, and it is assumed that the true model can be expressed by a linear combination of nonlinear terms.

\dot{X}=Θ(X)Ξ (1)

In the information processing device of the embodiment also, the above equation (1) is used, and it is assumed that the true model can be expressed by a linear combination of nonlinear terms. Then, the information processing device of the embodiment estimates a coefficient w in a library in the following equation (2) composed of nonlinear function candidates, using a machine learning technique.

$$Θ ( X ) = [ \begin{matrix}\vert & \vert & \vert & \vert & \vert & \vert \\ 1 & X & {X}^{P 2} & … & sin ( X ) & … \\ \vert & \vert & \vert & \vert & \vert & \vert\end{matrix} ] \qquad ( 2 )$$

The information processing device of the embodiment can significantly reduce the time required for learning and the amount of data required for learning, by defining a search space in the library.

In the following embodiment, a thermal circuit network model is generated as a model of a physical phenomenon. In a node equation of a thermal circuit network method expressed by the following equation (3), time change in temperature can be expressed as a linear combination of nonlinear terms.

$$\begin{matrix}{\sum }_{{j = 1}_{j \neq i}}^{N} \frac{1}{{R}_{ij}^{( m )}} ( {T}_{i}^{( m )} - {T}_{j}^{( m )} ) = {Q}_{i}^{( m )} - \frac{{C}_{i}^{( m )}}{Δ t} ( {T}_{i}^{( m )} - {T}_{i}^{( m - 1 )} ) \\ \to \frac{{dT}_{i}}{dt} = \frac{1}{{C}_{i}} \{ {Q}_{i} - {\sum }_{{j = 1}_{j \neq i}}^{N} \frac{1}{{R}_{ij}} ( {T}_{i} - {T}_{j} ) \}\end{matrix} \qquad ( 3 )$$

Consequently, there is a method of estimating a coefficient using a machine learning technique, by considering a library composed of candidates of a basis function proportional to the right-hand side. More specifically, the coefficient E is estimated by expressing the right-hand side of the above equation (3) as in the following equation (4).

$$\frac{dT}{dt} = Θ ( X ) Ξ , X = [ T , v , Q , … ] \qquad ( 4 )$$

Most of coefficients 8 of the given basis function are zero. Thus, the coefficient is estimated using a sparse estimation technique, which is a type of machine learning technique.

To estimate a coefficient, the fit to data is used as one index. In general, the sum of squared error is used as the index for the fit to data. For example, when an equation in which an L1 norm term is added to the sum of squared error is turned into a loss function, a sparse estimation technique called lasso is obtained as in the following equation (5).

min_{ξ}∥\dot{X}−Θ(X)Ξ∥₂² s.t. ∥Ξ∥₁≤s (5)

Because the sum of squared error is a weighted sum method in which the weight adjustment is ignored, the sum of squared error is strongly affected by the amount of the left-hand side. It is assumed that the left-hand side is a temperature gradient (time differential of temperature), and that the results of thermal fluid analysis are learned. To efficiently perform thermal fluid analysis, in general, varied time steps (Δt) of different lengths are used. That is, calculation is performed by narrowing Δt in the time zone where temperature changes rapidly, and calculation is performed by increasing Δt in the time zone where temperature changes gradually.

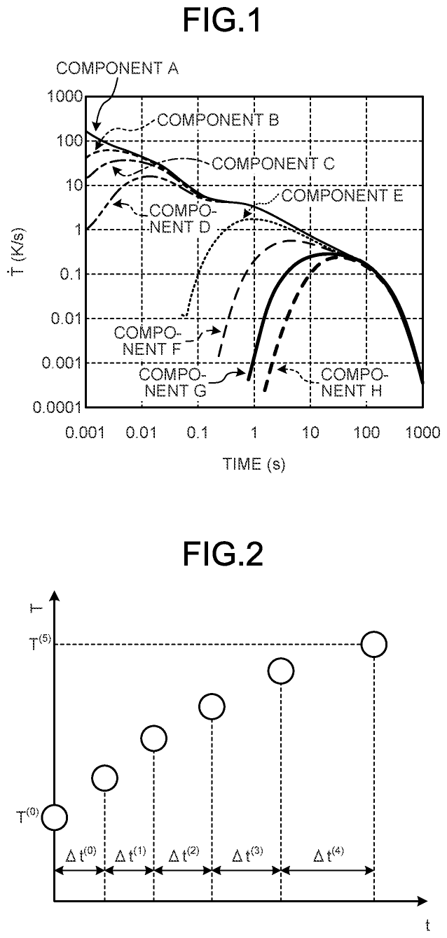

FIG. 1 is a diagram illustrating an example of temperature change in components obtained from certain results of thermal fluid analysis. In an example of a component D in FIG. 1, for example, a time zone where temperature changes rapidly up to 0.01s is calculated by narrowing the time step (Δt). For example, a time zone where temperature changes gradually from 0.1s to 1s is calculated by increasing the time step (Δt). As illustrated in FIG. 1, the temperature change in the object subject to thermal fluid analysis is often calculated by varying the time steps (Δt) such that the number of data is about the same for each order of magnitude of time (number of digits).

When the temperature gradient is calculated by a difference method and the like, the range is significantly widened. That is, it is temperature gradient of time zone where temperature changes rapidly >>temperature gradient of time zone where temperature changes gradually, and the coefficient estimation is significantly affected by the time zone where temperature changes rapidly. Moreover, when the learned model is used for designing, a super long-term prediction must be performed. Hence, a highly accurate short-term prediction is not enough. However, because the above equation (3) has a temperature dependency, it is not preferable to increase Δt by simply thinning data.

FIG. 2 is a diagram for explaining a time step (Δt). In the example in FIG. 2, temperatures T⁽⁰⁾ to T⁽⁵⁾ from time t⁽⁰⁾ to time t⁽⁵⁾ are illustrated. For example, in the case of FIG. 2, it is not preferable to increase the time step (Δt) by simply thinning the temperatures T⁽¹⁾ to T⁽⁴⁾ from the temperatures T⁽⁰⁾ to T⁽⁵⁾, and using a forward difference in the following equation (6), using a backward difference in the following equation (7), and the like.

$$\frac{{T}^{( 5 )} - {T}^{( 0 )}}{\sum Δ {t}^{( i )}} = f ( {T}^{( 5 )} ) \qquad ( 6 )$$

$$\frac{{T}^{( 5 )} - {T}^{( 0 )}}{\sum Δ {t}^{( i )}} = f ( {T}^{( 0 )} ) \qquad ( 7 )$$

Consequently, in an information processing device 1 of the embodiment, the coefficient that appears in the equation representing the amount of change from the initial temperature matches with the coefficient Ξ in the above equation (4). By taking the above into account, the time differential of the temperature, which is a short-term component, and the amount of change (difference) from the initial temperature, which is a long-term component, are mixed and used as learning data.

Hereinafter, an operation example of the information processing device of the embodiment capable of further improving the accuracy of generating a model of a physical phenomenon will be described in detail.

Example of Functional Configuration

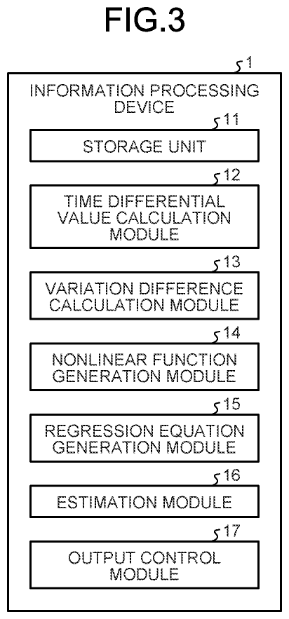

FIG. 3 is a diagram illustrating an example of a functional configuration of an information processing device 1 according to an embodiment. The information processing device 1 of the embodiment includes a storage unit 11, a time differential value calculation module 12, a variation difference calculation module 13, a nonlinear function generation module 14, a regression equation generation module 15, an estimation module 16, and an output control module 17.

The storage unit 11 stores therein time-series data including at least one of a dependent variable and an independent variable. The dependent variable (response variable) is a variable determined depending on the independent variable (explanatory variable). The independent variable is a variable representing the factor of change in the dependent variable. For example, the dependent variable is temperature of an electronic component, a heat sink, and the like. For example, the independent variable is wind velocity indicating the strength of air from a fan for cooling an electronic component, electric current that flows through the electronic component, voltage supplied to the electronic component, and the like.

In the information processing device 1 of the embodiment, the value of the dependent variable is expressed by a unit unified for each physical quantity represented by the dependent variable. For example, if the physical quantity is weight, the value of the dependent variable is unified to kg or g, without mixing the dependent variable expressed in kg and the dependent variable expressed in g. Similarly, the value of the independent variable is expressed by a unit unified for each physical quantity represented by the independent variable.

The storage unit 11 may also store a plurality of types of time-series data. In the types of time-series data, at least one of the initial condition and boundary condition may be different.

The time differential value calculation module 12 calculates a time differential value of a variable (dependent variable or independent variable) included in the time-series data. The time differential value of the variable included in the time-series data is used as learning data in the form of the above equation (4).

The variation difference calculation module 13 calculates a difference representing variation of a variable included in the time-series data from the initial value. More specifically, the variation difference calculation module 13 calculates the following equation (8), by discretizing the left-hand side of the above equation (4) with first order accuracy, for example, with forward differential.

$$\begin{matrix}[ \begin{matrix}{T}^{( 1 )} \\ {T}^{( 2 )} \\ {T}^{( 3 )} \\ ⋮\end{matrix} ] = [ \begin{matrix}{T}^{( 0 )} \\ {T}^{( 1 )} \\ {T}^{( 2 )} \\ ⋮\end{matrix} ] + [ \begin{matrix}{\dot{T}}^{( 1 )} {dt}^{( 1 )} \\ {\dot{T}}^{( 2 )} {dt}^{( 2 )} \\ {\dot{T}}^{( 3 )} {dt}^{( 3 )} \\ ⋮\end{matrix} ] = [ \begin{matrix}{T}^{( 0 )} \\ {T}^{( 0 )} \\ {T}^{( 0 )} \\ ⋮\end{matrix} ] + \\ [ \begin{matrix}{Θ ( X )}^{( 1 )} {dt}^{( 1 )} \\ {Θ ( X )}^{( 1 )} {dt}^{( 1 )} + {Θ ( X )}^{( 2 )} {dt}^{( 2 )} \\ {Θ ( X )}^{( 1 )} {dt}^{( 1 )} + {Θ ( X )}^{( 2 )} {dt}^{( 2 )} + {Θ ( X )}^{( 3 )} {dt}^{( 3 )} \\ ⋮\end{matrix} ] Ξ\end{matrix} \qquad ( 8 )$$

In this example, the superscript in the above equation (8) indicates time. By transforming the above equation (8) to the following equation (9), the variation difference calculation module 13 calculates a difference representing variation of the variable from the initial value.

ΔTₜ₌₀=Σᵢ₌₁^{t}Θ(X)⁽ⁱ⁾dt⁽ⁱ⁾Ξ (9)

The difference representing variation of the variable from the initial value included in the time-series data is used as learning data in the form of the above equation (9).

The nonlinear function generation module 14 generates a nonlinear function on the basis of at least one of the dependent variable and the independent variable. For example, the nonlinear function generation module 14 generates a nonlinear function on the basis of temperature Tᵢ at a position i, and temperature Tⱼ at a position j.

The regression equation generation module 15 generates a linear regression equation in which the nonlinear function generated by the nonlinear function generation module 14 is used as a basis function.

The estimation module 16 estimates the coefficient of the linear regression equation generated by the regression equation generation module 15, by machine learning in which the time differential value and the difference are used as learning data. More specifically, the estimation module 16 estimates the coefficient of the linear regression equation by machine learning, using both of the learning data in the form of the above equation (4) and the learning data in the form of the above equation (9).

The coefficient Ξ in the above equation (4) and the coefficient Ξ in the above equation (9) are the same. The above equation (9) can advantageously handle the nonlinear basis function and varied time steps (Δt) of different lengths. By transforming the time-series data in the forms of the above equations (4) and (9), mixing the time-series data, and using the mixed time-series data as learning data, learning in which the short-term component and the long-term component are taken into consideration becomes possible. In this manner, compared to when only the short-term component is taken into consideration, it is possible to further improve the accuracy of long-term prediction by the model generated by learning.

If the short-term component is only taken into consideration, the accuracy of long-term prediction by the model is degraded. Alternatively, if the long-term component is only taken into consideration, the accuracy of short-term prediction by the model is degraded. If the short-term prediction is not correct, the accuracy of long-term prediction by the model is also degraded.

The least square method used in machine learning is a weighted sum method in which the weight adjustment is ignored. Hence, to further improve the accuracy of the model, it is important to perform preprocessing on the learning data such that the following equation (10) is obtained.

αΣᵢΔTₜ₌₀=Σᵢ\dot{T} (10)

In this example, i is the number of data, a is weight and satisfies α>1. That is, the total sum of the time differential values of the variables included in the learning data is larger than the total sum of differences representing variations of the variables from the initial value.

Moreover, in the example of the embodiment, for example, the basis function candidate includes addition and subtraction of variables to and from each other as in the right-hand side of the following equation (11), and the calculation results have physical meanings. Hence, inconvenience occurs when the variables (dependent variables and independent variables) are normalized. As a result, the estimation module 16 estimates the coefficient of a linear regression equation by a machine learning method in which normalization of variables is not required.

$$\begin{matrix}[ \begin{matrix}\vert & \vert & \vert & \vert & … \\ {\dot{T}}_{1} & {\dot{T}}_{2} & {\dot{T}}_{3} & {\dot{T}}_{4} & … \\ \vert & \vert & \vert & \vert & …\end{matrix} ] = \\ [ \begin{matrix}\vert & \vert & \vert & \vert & … \\ {T}_{1} - {T}_{2} & {\vert \frac{{T}_{1} - {T}_{2}}{{T}_{1} + {T}_{2}} \vert}^{β} & ( {T}_{2} - {T}_{5} ) {v}^{α} & {T}_{2}^{γ} - {T}_{4}^{γ} & … \\ \vert & \vert & \vert & \vert & …\end{matrix} ] Ξ\end{matrix} \qquad ( 11 )$$

When a certain convergence condition is satisfied, the output control module 17 outputs a linear regression equation expressed by the corrected coefficient. For example, the certain convergence condition includes the number of repetition times of the machine learning process and the like.

Example of Generation Method of Model

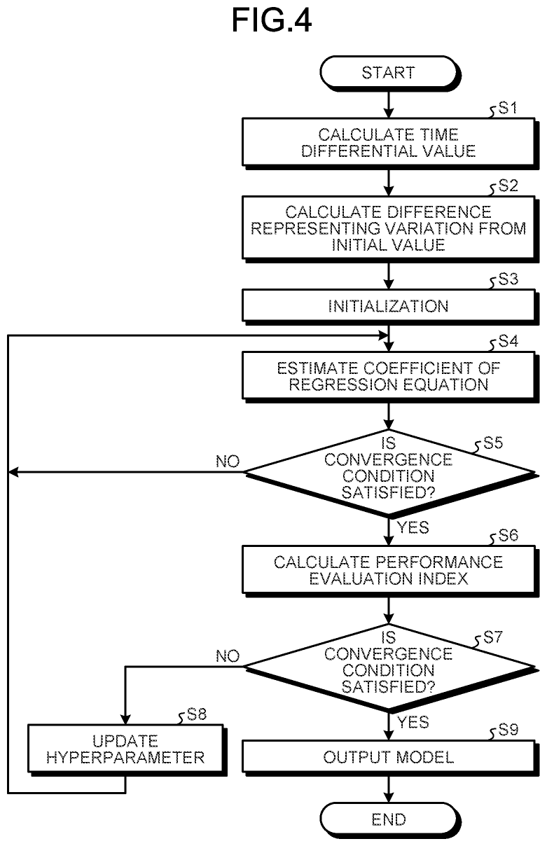

FIG. 4 is a flowchart illustrating an example of a generation method of a model according to the embodiment. First, the time differential value calculation module 12 calculates a time differential value of a variable (dependent variable or independent variable) included in the time-series data (step S1). Next, the variation difference calculation module 13 calculates a difference representing variation of a variable included in the time-series data from the initial value (step S2).

Next, the information processing device 1 initializes the data used when the model is machine learnt (for example, a hyperparameter and the like) (step S3).

Next, the estimation module 16 estimates the coefficient of a linear regression equation generated by the regression equation generation module 15, by the machine learning in which the time differential value calculated at step S1 and the difference calculated at step S2 are used as learning data (step S4). More specifically, the time differential value of a variable included in the time-series data is used as learning data in the form of the above equation (4), and the difference representing variation of a variable included in the time-series data from the initial value is used as learning data in the form of the above equation (9).

For example, for the learning data used in the estimation process at step S4, a part of data may be selected at random from the entire learning data. Moreover, for example, the learning data used in the estimation process at step S4 may also be sequentially selected from unused data included in the learning data.

Next, the estimation module 16 determines whether the result of the coefficient estimation process has satisfied the convergence condition (step S5). For example, the convergence condition includes the number of times the coefficient estimation process is executed.

When the convergence condition is not satisfied (No at step S5), the process returns to step S4. When the convergence condition is satisfied (Yes at step S5), the output control module 17 calculates a performance evaluation index of the model (step S6). Next, the output control module 17 determines whether the learned model has satisfied the convergence condition (step S7). For example, the convergence condition is the number of times the learning processes (steps S4 to S6) of the model are executed. Moreover, for example, the convergence condition is when the performance evaluation index calculated by the process at step S6 is greater than a predetermined evaluation threshold. When the convergence condition is not satisfied (No at step S7), the hyperparameter is updated (step S8), and the process returns to step S4.

When the convergence condition is satisfied (Yes at step S7), the output control module 17 outputs the model (step S9).

Explanation of Effects

Next, accuracy of the model generated by the information processing device 1 of the embodiment will be described.

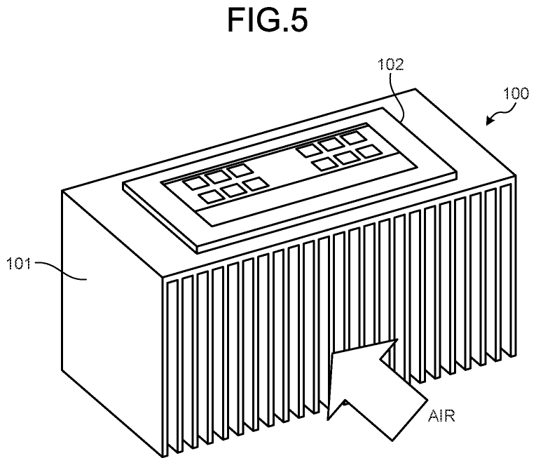

FIG. 5 is a diagram illustrating an example of a power electronic apparatus 100 that is an object subject to thermal fluid analysis. The power electronic apparatus 100 includes a heat sink 101 and an electronic apparatus 102. The heat sink 101 cools the electronic apparatus 102. Air is blown to the heat sink 101 from a fan. The electronic apparatus 102 controls the operation of the power electronic apparatus 100. For example, the power electronic apparatus 100 is a power module.

For example, the information processing device 1 of the embodiment generates a model that expresses a thermal fluid analysis with several million nodes with 60 nodes, for example, by performing the machine learning described above, using the time-series data including the temperature history of 60 nodes of the thermal fluid analysis to be performed on the power electronic apparatus 100.

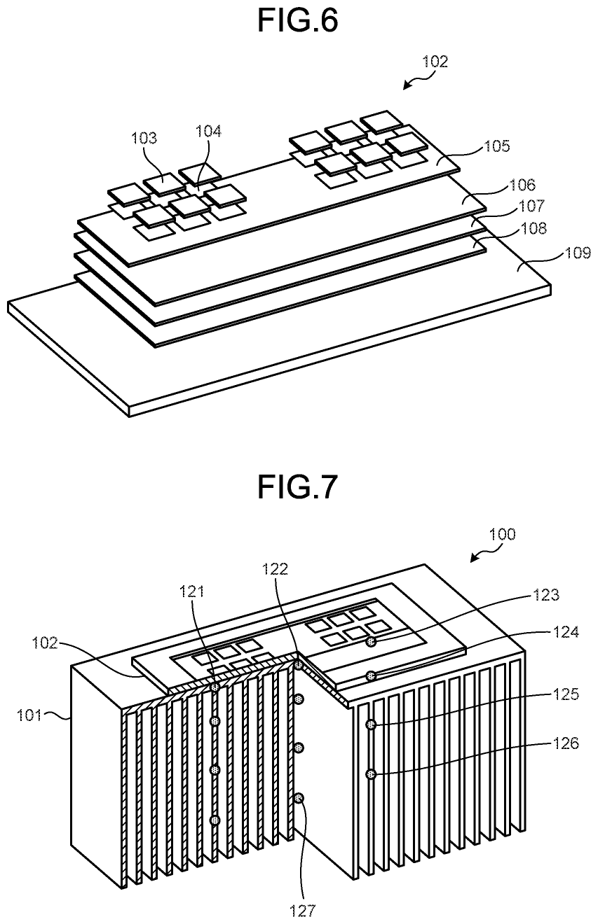

FIG. 6 is a diagram illustrating an example of a component configuration of the electronic apparatus 102. The electronic apparatus 102 includes a chip 103, a bonding member 104, a component 105, a component 106, a component 107, a boding member 108, and a component 109.

FIG. 7 is a diagram illustrating an example of temperature measurement points (nodes) on the heat sink 101. The temperature history of the heat sink 101 is measured at a plurality of nodes including nodes 121 to 127 and the like.

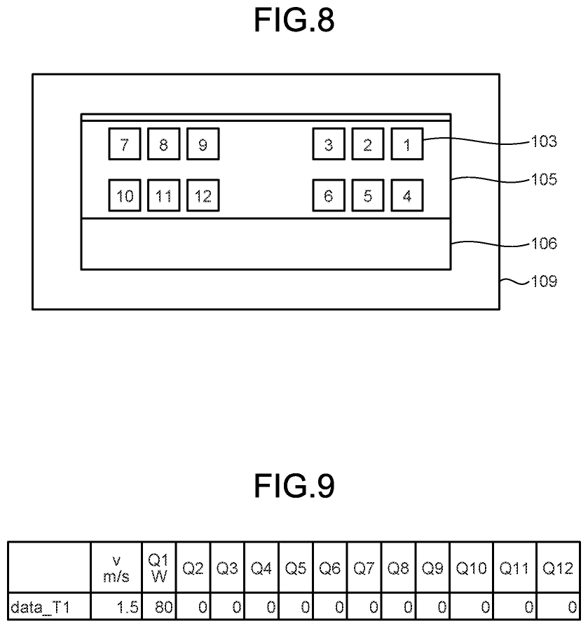

FIG. 8 is a diagram illustrating an example of the number and position of the chip 103 of the power electronic apparatus 100. For example, in the power electronic apparatus 100, the first to twelfth chips 103 are mounted and arranged as illustrated in FIG. 8. The chips 103 at the first to twelfth positions are each indicated as a chip_1 to a chip_12.

In verification of the effectiveness of the model generated by the information processing device 1 of the embodiment to be described below, the input data includes 73 variables (heat generation amount of the chip_1 to chip_12, wind velocity of a fan that blows air to the heat sink, and initial temperature at 60 locations (nodes)), and the output data includes 60 variables (temperature at 60 locations). Moreover, the learning data is results of thermal fluid analysis performed twelve times. The range of learning data includes the heat generation amount of 1 to 69 W, and the wind velocity 1.0 to 2.0 m/s of the fan. The range of evaluation data (unknown input data not included in the learning data) includes the heat generation amount of 0 to 80 W, and the wind velocity 1.5 to 3.5 m/s of the fan.

FIG. 9 is a diagram illustrating Example 1 of unknown input data to be input into the model generated by the information processing device 1 according to the embodiment. v represents the speed of wind (wind velocity) blown to the heat sink 101. Q1 to Q12 represent the heat generation amount of the chip_1 to chip_12.

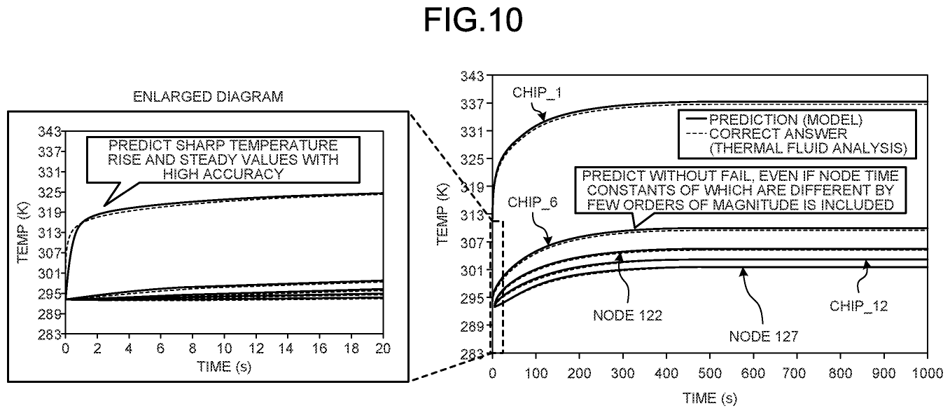

FIG. 10 is a diagram illustrating Example 1 of results (when Example 1 of input data is input) predicted by the model generated by the information processing device 1 according to the embodiment. In the example of FIG. 10, prediction results of temperature change at the node included in each of the chip_1, chip_6, and chip_12, and at the nodes 122 and 127 of the heat sink 101 are illustrated. The dotted line indicates the result predicted by the model. The solid line indicates the result (correct answer) of thermal fluid analysis. As illustrated in the prediction result of the temperature change at the chip_1, the model generated by the information processing device 1 of the embodiment can predict the sharp temperature rise immediately after the start of measurement and the steady values afterward with high accuracy. Moreover, the model is predicting the temperature change without fail, even if a node is included in an object to be measured in which the time constants are different by a few orders of magnitude.

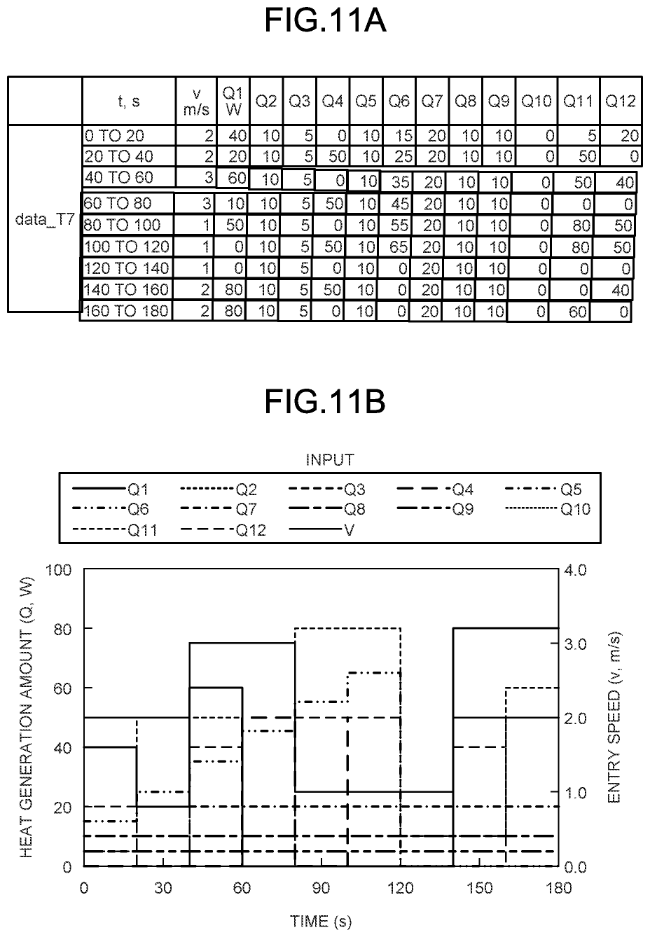

FIG. 11A and FIG. 11B are each a diagram illustrating Example 2 of input data of the model generated by the information processing device 1 according to the embodiment. In Example 2 of the input data, the heat generation amount is not constant, and is varied as in FIG. 11B.

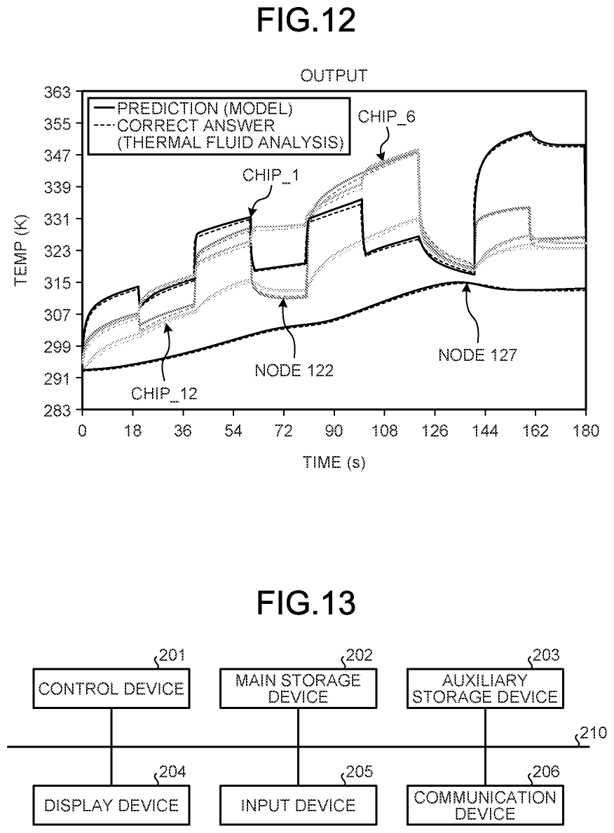

FIG. 12 is a diagram illustrating Example 2 of results (when Example 2 of input data is input) predicted by the model generated by the information processing device 1 according to the embodiment. As illustrated in FIG. 12, even if the heat generation amount is varied, the model generated by the information processing device 1 of the embodiment can predict the temperature change at the node included in each of the chip_1, the chip_6, and the chip_12, and the nodes 122 and 127 of the heat sink 101 with high accuracy.

As described above, in the information processing device 1 of the embodiment, the storage unit 11 stores therein the time-series data including one or more variables. The time differential value calculation module 12 calculates the time differential value of the variable. The variation difference calculation module 13 calculates a difference representing variation of the variable from the initial value. The estimation module 16 estimates the coefficient of a linear regression equation, by machine learning in which the time differential value and the difference are used as learning data. Then, the output control module 17 outputs the linear regression equation.

In this manner, with the information processing device 1 of the embodiment, it is possible to further improve the accuracy of generating a model of a physical phenomenon.

While the above-described embodiment describes a case where the information processing device 1 generates the linear regression equation of the thermal model, the linear regression equation of a model of another physical phenomenon (for example, electric resistance or physical deformation amount) may be generated.

Finally, an example of a hardware configuration of the information processing device 1 of the embodiment will be described.

Example of Hardware Configuration

FIG. 13 is a diagram illustrating an example of a hardware configuration of the information processing device 1 according to the embodiment.

The information processing device 1 of the embodiment includes a control device 201, a main storage device 202, an auxiliary storage device 203, a display device 204, an input device 205, and a communication device 206. The control device 201, the main storage device 202, the auxiliary storage device 203, the display device 204, the input device 205, and the communication device 206 are connected via a bus 210.

The control device 201 executes a computer program read out to the main storage device 202 from the auxiliary storage device 203. The main storage device 202 is memory such as read only memory (ROM) and random access memory (RAM). The auxiliary storage device 203 is a hard disk drive (HDD), a memory card, and the like.

The display device 204 displays display information. For example, the display device 204 is a liquid crystal display and the like. The input device 205 is an interface for operating the information processing device 1. For example, the input device 205 is a keyboard, a mouse, and the like. When the information processing device 1 is a smartphone or a smart device such as a tablet-type terminal, for example, the display device 204 and the input device 205 are a touch panel.

The communication device 206 is an interface for communicating with another device and the like.

A computer program executed by the information processing device 1 of the embodiment is recorded on a computer-readable storage medium such as a compact disc-read only memory (CD-ROM), a memory card, a compact disc-recordable (CD-R), and a digital versatile disc (DVD) in an installable or executable file format, and is provided as a computer program product.

Moreover, the computer program executed by the information processing device 1 of the embodiment may also be stored on a computer connected to a network such as Internet, and may be provided by causing a user to download the computer program via the network. Furthermore, the computer program executed by the information processing device 1 of the embodiment may also be provided via a network such as Internet without causing a user to download the computer program.

Still furthermore, the computer program of the information processing device 1 of the embodiment may also be provided by being incorporated in advance in ROM or the like.

The computer program executed by the information processing device 1 of the embodiment has a modular configuration including functional blocks that can also be implemented by a computer program among the functional blocks described above (FIG. 3). The functional blocks, as actual hardware, are loaded onto the main storage device 202, when the control device 201 reads the computer program from the storage medium, and executes the computer program. That is, the functional blocks are generated on the main storage device 202.

A part or the whole of the functional blocks described above may be implemented by hardware such as an integrated circuit (IC) instead of being implemented by software.

Moreover, when the functions are implemented using a plurality of processors, each processor may implement one of the functions or implement two or more functions.

Furthermore, an operating mode of the information processing device 1 of the embodiment may be optional. For example, the information processing device 1 of the embodiment may be operated as a cloud system on a network.

While certain embodiments have been described, these embodiments have been presented by way of example only, and are not intended to limit the scope of the inventions.

Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device, comprising:
a memory configured to store therein time-series data including one or more variables;
one or more processors coupled to the memory and configured to:
calculate one or more time differential values of the one or more variables;
calculate one or more differences representing variation of the one or more variables from an initial value;
estimate a coefficient of a linear regression equation by machine learning in which the time differential values and the differences are used as learning data; and
output the linear regression equation.

2. The device according to claim 1, wherein a total sum of the time differential values included in the learning data is greater than a total sum of the differences.

3. The device according to claim 1, wherein
the one or more processors are further configured to:
generate a nonlinear function based on the one or more variables; and
generate the linear regression equation by using the nonlinear function as a basis function.

4. The device according to claim 1, wherein the one or more variables include at least one of a dependent variable and an independent variable.

5. The device according to claim 4, wherein a left-hand side of the linear regression equation is a time differential of the dependent variable.

6. The device according to claim 1, wherein each of the one or more variables includes an unnormalized value.

7. The device according to claim 1, wherein a value of each of the one or more variables is expressed by a unit unified for each physical quantity represented by a corresponding variable of the one or more variables.

8. The device according to claim 1, wherein
the memory stores therein a plurality of types of the time-series data, and
the types of time-series data are time-series data in which at least one of an initial condition and a boundary condition differs.

9. An information processing method, comprising:
storing time-series data including one or more variables;
calculating one or more time differential values of the one or more variables;
calculating one or more differences representing variation of the one or more variables from an initial value;
estimating a coefficient of a linear regression equation by machine learning in which the time differential values and the differences are used as learning data; and
outputting the linear regression equation.

10. A computer program product comprising a non-transitory computer readable medium including programmed instructions, the instructions causing a computer to execute:
storing time-series data including one or more variables;
calculating one or more time differential values of the one or more variables;
calculating one or more differences representing variation of the one or more variables from an initial value;
estimating a coefficient of a linear regression equation by machine learning in which the time differential values and the differences are used as learning data; and
outputting the linear regression equation.
